(19) United States
(12) Patent Application Publication
(10) Pub. No.: US 2007/0048520 A1
(43) Pub. Date: Mar. 1, 2007

(54) Thermal interface material and method for making the same

(75) Inventors: Bor-Yuan Hsiao, Tu-Cheng (TW); Chun-Yi Chang, Tu-Cheng (TW); Tsai-Shih Tung, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/440,292

(22) Filed: May 24, 2006

(30) Foreign Application Priority Data
Aug. 26, 2005 (CN) 200510036907.4

(51) Int. Cl. B32B 5/16; B32B 15/04; B05D 1/36; B05D 1/18; B05D 1/12

(52) U.S. Cl. 428/328; 428/457; 428/339; 428/337; 427/402; 427/430.1; 427/180

(57) ABSTRACT

A thermal interface material and a making method thereof are disclosed. The thermal interface material includes a thermal conductive substrate having a first surface and an opposing second surface; and at least one organic metal multilayer film formed on at least one of the first and second surfaces. The organic metal multilayer film comprises a plurality of metal layers and a plurality of organic layers. Each of the metal layers and each of the organic layers are alternately linked to one by another. Each of the metal layers comprises a plurality of metal particles each in contact with one or more organic molecules of adjacent organic layers.

### TECHNICAL FIELD

The invention relates generally to thermal interface devices and, more particularly, to a thermal interface material and a making method thereof.

### BACKGROUND

Electronic components such as semiconductor chips are becoming progressively smaller, while at the same time heat dissipation requirements thereof are increasing. Commonly, a heat sink is disposed upon the electronic component in order to efficiently dissipate heat generated by the electronic component.

Typically, the heat sink has a flat surface to couple to an opposition flat surface of the electronic component. Generally, the two flat surfaces, i.e., heat transfer surfaces, are rarely perfectly planar or smooth due to tolerance stack-ups or uneven component heights, so air gaps would unduly exist between the two flat surfaces. The air gaps cause thermal resistance between the two flat surfaces thereby decreasing the ability to transfer heat through an interface therebetween. Thus, the air gaps reduce the effectiveness and value of the heat sink as a thermal management device. To address this problem, various thermal interface materials (thereinafter, TIMs) and structures, for example, thermal greases and compliant pads, have been developed for placement between the heat transfer surfaces to decrease the thermal resistance therebetween.

A typical thermal grease is generally a paste-like substance that is spread over one or both of the heat transfer surfaces before the surfaces are mated. When the surfaces are subsequently brought together, the thermal grease fills the air gaps between the surfaces, thus improving the thermal transfer properties of the interface. However, thermal greases are typically difficult to apply and tend to bleed from the interface region or dry out during circuit operation. In addition, some thermal greases are conductive and can cause short circuits within an electrical system.

Thermal pads are generally thin flat films interposed between the heat transfer surfaces to reduce thermal resistance. The thermal pads are relatively more convenient to be used than thermal greases, but have disadvantages of, for example, relatively low compressibility and flexibility.

At present, a new kind of TIM is made by filling particles with a high heat conduction coefficient in a matrix material. The particles can be made of graphite, boron nitride, silicon oxide, alumina, silver, or other metals. However, the particles are discretely distributed in the matrix material. Thus, the particles cannot form continuous heat conduction paths therebetween in the matrix material, thereby decreasing heat conductivity of the entire TIM. Therefore, the filled TIM now cannot adequately meet the heat dissipation requirements of modern electronic components.

What is needed, therefore, is a TIM that is compressible to fill gaps between heat transfer surfaces and has enhanced heat transfer efficiency.

What is also needed, therefore, is a method for making the above-described TIM.

### SUMMARY

In accordance with a preferred embodiment, a TIM includes a thermal conductive substrate having a first surface and an opposing second surface; and at least one organic metal multilayer film formed on at least one of the first and second surfaces.

In accordance with another embodiment, a method for making the TIM includes the steps of: providing a thermal conductive substrate having a first surface and an opposing second surface; and forming at least one organic metal multilayer film on at least one of the first and second surfaces of the thermal conductive substrate.

Other objects, advantages and novel features of the invention will become more apparent from the following detailed description when taken in conjunction with the accompanying drawings.

### BRIEF DESCRIPTION OF THE DRAWINGS

Many aspects of the TIM can be better understood with reference to the following drawings. The components in the drawings are not necessarily to scale, the emphasis instead being placed upon clearly illustrating the principles of the present TIM. Moreover, in the drawings, like reference numerals designate corresponding parts throughout the several views.

FIG. 1 is a schematic side view of a TIM according to a preferred embodiment;

FIG. 2 is similar to FIG. 1, but showing a microstructure of the TIM of FIG. 1;

FIG. 3 is similar to FIG. 1, but showing an exemplary application of the TIM of FIG. 1;

FIG. 4 is a schematic flow chart of a method for making the TIM of FIG. 1;

FIGS. 5A, 5B, 5C illustrate a schematic flow chart of an exemplary process for performing the second step of FIG. 4; and

FIGS. 6A, 6B, 6C are similar to FIGS. 5A, 5B, 5C, respectively, but showing molecule structure changes during the exemplary process of FIGS. 5A, 5B, 5C, respectively.

### DETAILED DESCRIPTION OF THE PREFERRED EMBODIMENTS

Embodiments of the present TIM will now be described in detail below and with reference to the drawings.

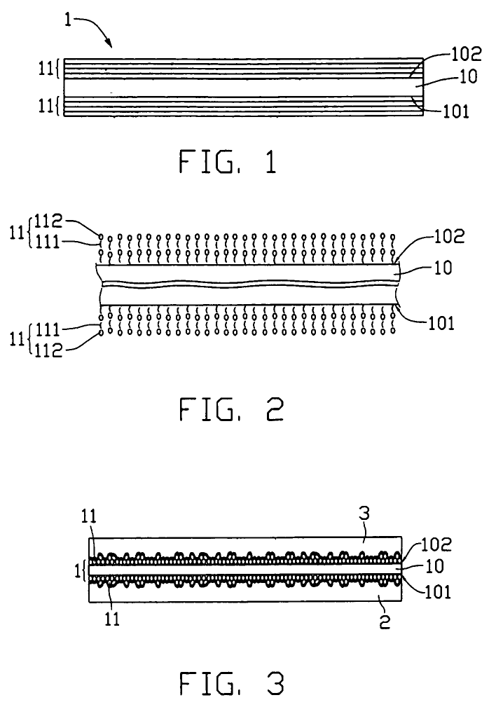

Referring to FIGS. 1 and 2, a TIM 1 includes a metallic substrate 10, two organic metal multilayer films 11. The metallic substrate 10 has a first surface 101 and an opposing second surface 102. The first and second surfaces 101, 102 are preferably parallel to each other. The two organic metal multilayer films 11 are formed on the first and second surface 101 and 102, respectively.

The metallic substrate 10 is advantageously made by thermal conductive metals such as gold, silver, copper, aluminum, nickel, or an alloy thereof. The metallic substrate 10 is advantageously in a sheet form and has a thickness in the approximate range from 10 micrometers to 200 micrometers. Preferably, the first and second surfaces 101 and 102 are substantially smooth and planar.

Alternatively, the metallic substrate 10 could be a thermal conductive non-metal substrate having metallic first and second surfaces 101 and 102 formed thereon. The metallic first and second surfaces 101 and 102 could be formed, for example, by forming two metal films on the non-metal substrate. The non-metal substrate could be selected from thermal conductive metal compounds, e.g., metal oxides like alumina and titania, or metal nitrides like aluminum nitride and boron nitride.

The two organic metal multilayer films 11 each include a plurality of organic films 111 and a plurality of metal films 112. The two organic metal multilayer films 11 each are beneficially linked to the first and second surfaces 101 and 102 by one organic film 111 or one metal layer 112, respectively. Preferably, the organic films 111 and the metal layers 112 are alternately linked to one by another via chemical bonds. The chemical bonds could, advantageously, be covalent bonds. These chemical bonds, the organic layers 111, and the metal layers 112 cooperatively form a plurality of continuous heat conduction paths thereby decreasing an inner thermal resistance of the TIM 1 and enhancing heat transfer efficiency. The organic metal multilayer films 11 each advantageously have a total thickness in the approximate range from 1 micrometer to 10 micrometers.

The organic layers 111 are advantageously comprised of, for example, an organic molecule having a function group prone to bonding with a metal particle, such as, for example, 1, 5-pentanedithiol, 1, 6- hexanedithiol, 1, 9-nonanedithiol, other dithoils or polythoils. Thus, the chemical bonds, e.g., covalent bonds, are formed between the metal particles and sulfur atoms.

Each of the metal layers 112 beneficially includes a plurality of metal particles each being in contact with one or more organic molecules of adjacent organic layers 111. The metal particles are advantageously comprised of, for example, a thermal conductive metal material selected from the group consisting of: gold, silver, copper, aluminum, and combinations thereof. The metal particles advantageously have an average grain size in the approximate range from 1 nanometer to 100 nanometers.

FIG. 3 illustrates an exemplary application of the TIM 1 for dissipating heat from a heat source. Generally, the TIM 1 is interposed between a heat source 2 (e.g., an electronic component) and a heat sink 3. The two organic metal multilayer films 11 are advantageously thermally coupled to the heat source 2 and the heat sink 3, respectively. The TIM 1, the heat sink 2, and the heat source 3 thereby cooperatively form a thermal management system.

In general, a fastening member, e.g., a fastener or a clamp, is applied for fastening the heat sink 3 and TIM 1 onto the heat source 2. Thus, in operation, the TIM 1 is subjected to a certain pressure (generally about 4˜11 Kg/cm²) from the fastening member. Because the two organic metal multilayer films 11 are compressible, the two organic metal multilayer films 11 would fill in gaps between the TIM 1 and the heat source 2, as well as gaps between the TIM 1 and the heat sink 3. This would decrease interface thermal resistances from the heat source 2 to the TIM 1, and then from the TIM 1 to the heat sink 3, thereby promoting heat transfer efficiency between the heat source 2 and the heat sink 3.

Furthermore, in an alternative embodiment, only one organic metal multilayer film 111 is formed on either the first or second surfaces 101, 102 of the metallic substrate 10.

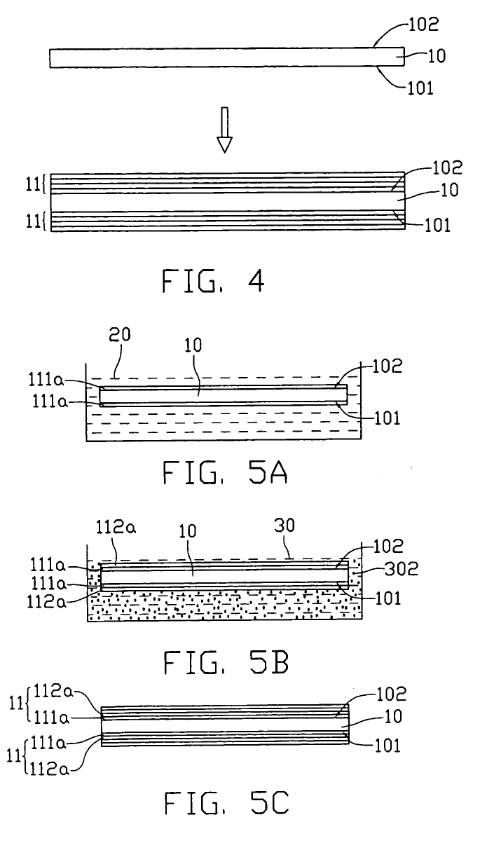

FIG. 4 shows a flow chart of a method for making the above-described TIM 1. In the illustrated embodiment, the making method mainly includes the following steps: providing a metallic substrate 10 having a first surface 101 and an opposing second surface 102; and forming two organic metal multilayer films 11 on the first and second surfaces 101 and 102 of the metallic substrate 10.

The metallic substrate 10 is advantageously a thermal conductive metal substrate, as described above. If the metallic substrate 10 employs a thermal conductive non-metal substrate, a metal film could be formed on two opposing surfaces of the non-metal substrate by a method, such as, for example, a chemical vapor deposition method, an electroplating method, or an electroless plating method.

FIG. 5 illustrates an exemplary process for performing the second step, i.e., the formation of the two organic metal multilayer films 11. The provided metallic substrate 10 is immersed into a dithoil solution 20 to form a pair of first organic layers 111a on the first and second surfaces 101 and 102 of the metallic substrate 10, respectively, as shown in FIG. 5A. In the illustrated embodiment, the metallic substrate 10 is wholly immersed into the dithoil solution 20 to submerge the first and second surfaces 101, 102. In an alternative embodiment, in order to form an organic metal film on one of the first and second surfaces 101, 102, only one surface of the metallic substrate 10 is immersed into the dithoil solution 20, and the other surface of the metallic substrate 10 is kept out of the dithoil solution 20.

The dithoil solution 20 essentially includes a dithoil solute, e.g., 1, 5-pentanedithiol, 1, 6- hexanedithiol, or 1, 9-nonanedithiol, and an organic solvent, e.g., pentane, hexane, nonane, or alcohol. The dithoil solution 20 advantageously has a dithoil concentration in the approximate range from 1×10⁻⁴ mol/L to 1×10⁻¹ mol/L. In another embodiment, the solution 20 could be a polythiol solution.

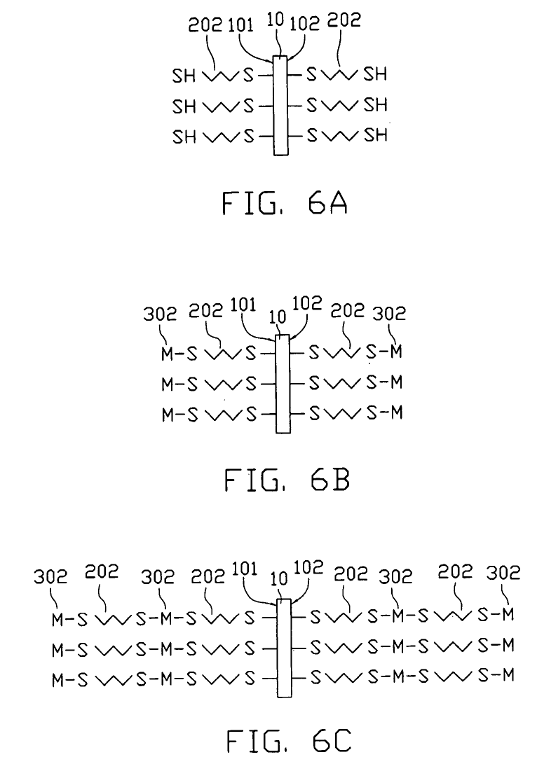

Each dithiol molecule typically has two sulfhydryl groups (—SH). During the immersing process, a hydrogen atom site of one sulfhydryl group (—SH) of each dithoil molecule would be replaced with a metal atom thereby linking the dithiol molecule to one surface of the metallic substrate 10. The other sulfhydryl group (—SH) of each dithoil molecule is distal from the respective surface of the metallic substrate 10. As such, for an enough long time, e.g., 12˜36 hours, the first and second surfaces 101 and 102 of the metallic substrate 10 each would link with a plurality of dithiol molecules 202 thereby forming a pair of first organic layers 111a thereon and remaining a plurality of distal sulfhydryl groups (—SH) away from the respective surfaces, as shown in FIG. 6A.

FIG. 5B illustrates an exemplary formation process of a first metal layer on each first organic layer. The metallic substrate 10 with the two first organic layers 111a is immersed into a metal particle solution 30 to form a pair of first metal layers 112a thereon, respectively. The metal particle solution 30 includes a plurality of metal particles 302 suspending therein. The metal particles 302 advantageously have a concentration in the approximate range from 1×10⁻⁴ mol/L to 1×10⁻¹ mol/L. The metal particles 302 advantageously have an average grain in the approximate range from 1 nanometer to 100 nanometers. The metal particle solution 30 could employ water, alcohol, or hexane as solvent.

During the immersing of the metallic substrate 10 into the metal particle solution 30, the distal sulfhydryl groups (—SH) of each first organic layer 111a are readily contact with the metal particles 302 of the metal particle solution 30. Then, the metal atoms would replace hydrogen atoms of the distal sulfhydryl groups thereby linking the metal particles 302 to the two first organic layers 111a, i.e., forming a pair of first metal layers 112a, as shown in FIG. 6B.

Then, the metallic substrate 10, having two pairs of first organic layers 111a and first metal layers 112a thereon, is immersed into the dithoil solution 20 and sequentially the metal particle solution 30 again and again, thereby forming a pair of organic metal layers 11 thereon, as shown in FIGS. 5C and 6C. It is to be noted that the immersing process into the dithoil solution 20 and the metal particle solution 30 could be repeated enough multiples for satisfying various requirements in factual applications.

It is understood that the above-described embodiments and methods are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A thermal interface material comprising:
a thermal conductive substrate having a first surface and an opposing second surface; and
at least one organic metal multilayer film formed on at least one of the first and second surfaces.

2. The thermal interface material as claimed in claim 1, wherein the organic metal multilayer film comprises a plurality of metal layers and a plurality of organic layers.

3. The thermal interface material as claimed in claim 1, wherein each of the metal layers and each of the organic layers are alternately linked to one by another.

4. The thermal interface material as claimed in claim 3, wherein each of the metal layers comprises a plurality of metal particles each in contact with one or more organic molecules of adjacent organic layers.

5. The thermal interface material as claimed in claim 4, wherein the metal particles are comprised of a thermal conductive metal material selected from the group consisting of: gold, silver, copper, aluminum, and combinations thereof.

6. The thermal interface material as claimed in claim 4, wherein the metal particles have an average grain size in the approximate range from 1 nanometer to 100 nanometers.

7. The thermal interface material as claimed in claim 1, wherein the at least one organic metal multilayer film comprises two organic metal multilayer films respectively formed on the first and second surfaces of the metal substrate.

8. The thermal interface material as claimed in claim 2, wherein the organic layers are comprised of an organic material selected from the group consisting of: 1, 5-pentanedithiol, 1, 6-hexanedithiol, and 1, 9-nonanedithiol.

9. The thermal interface material as claimed in claim 1, wherein the at least one organic metal multilayer film has a thickness in the approximate range from 1 micrometer to 10 micrometers.

10. The thermal interface material as claimed in claim 1, wherein the thermal conductive substrate has a thickness in the approximate range from 10 micrometers to 200 micrometers.

11. The thermal interface material as claimed in claim 1, wherein the thermal conductive substrate is one of a thermal conductive metal substrate and a thermal conductive non-metal substrate having a metal film formed on at least one of the first and second surfaces.

12. The thermal interface material as claimed in claim 1, wherein the first and second surfaces are substantially parallel to each other.

13. A method for making a thermal interface material, comprising the steps of:
providing a thermal conductive substrate having a first surface and an opposing second surface; and
forming at least one organic metal multilayer film on at least one of the first and second surfaces of the thermal conductive substrate.

14. The method according to claim 13, wherein the formation step of at least one organic metal multilayer film comprises the steps of: forming a first organic layer on at least one of the first and second surfaces of the thermal conductive substrate; forming a first metal layer on the first organic layer; repeatedly performing the two prior steps to form the at least one organic metal multilayer film on at least one of the first and second surfaces of the thermal conductive substrate.

15. The method according to claim 14, wherein the formation step of the first organic layer comprises step of immersing the at least one of the first and second surfaces of the thermal conductive substrate into a dithoil solution.

16. The method according to claim 15, wherein the dithoil solution has a dithoil concentration in the approximate range from 1×10⁻⁴ mol/L to 1×10⁻¹ mol/L.

17. The method according to claim 14, wherein the formation of the first metal layer comprises step of immersing the first organic layer into a metal particle solution.

18. The method according to claim 14, wherein the metal particle solution has a metal particle concentration in the approximate range from 1×10⁻⁴ mol/L to 1×10⁻¹ mol/L.

19. A thermal management system comprising:
a heat source;
a heat sink; and
a thermal interface material interposed between the heat source and the heat sink, the thermal interface material comprising:
a thermal conductive substrate having a first surface and an opposing second surface; and
at least one organic metal multilayer film formed on at least one of the first and second surfaces, the at least one organic metal multilayer film comprising metal layers and organic layer alternately linked one another, each of the metal layers containing metal nanoparticles.
